(19) United States
(12) Patent Application Publication
(10) Pub. No.: US 2026/0218333 A1
(43) Pub. Date: Jul. 30, 2026

(54) SPODUMENE CONCENTRATION FOR LITHIUM RECOVERY

(71) Applicant: RIO TINTO IRON AND TITANIUM CANADA INC., Sorel-Tracy (CA)

(72) Inventors: Mathieu Fillion, Varennes (CA); Alex-Antoine Belval, Sorel-Tracy (CA); Gianni Bartolacci, Québec (CA)

(21) Appl. No.: 19/145,802

(22) PCT Filed: Jan. 8, 2024
(86) PCT No.: PCT/CA2024/050016

§ 371 Date: Jul. 3, 2025

Related U.S. Application Data
(60) Provisional application No. 63/479,045, filed on Jan. 9, 2023.

(51) Int. Cl. C22B 26/12; B03C 1/02; C01D 15/02; C01D 15/08; C22B 1/00; H01M 10/0525

(52) U.S. Cl. CPC C22B 26/12; B03C 1/02; C01D 15/02; C01D 15/08; C22B 1/005; H01M 10/0525

(57) ABSTRACT

There is provided a method of recovering lithium concentrate from an ore containing spodumene. The ore is crushed to obtain a fine fraction and a coarse fraction. The coarse fraction is calcined at a temperature of from about 950 to about 1100° C. to obtain a calcined coarse fraction containing spodumene particles having a beta crystal structure. The calcined coarse fraction is selectively screened to separate out the spodumene particles and produce screened spodumene particles. A magnetic separation is performed on the screened spodumene particles to concentrate the spodumene particles and separate out non-magnetic contaminants to recover the lithium concentrate.

### CROSS-REFERENCE TO RELATED APPLICATION

The present application is claiming priority from U.S. Provisional Application No. 63/479,045 filed Jan. 9, 2023, the content of which is hereby incorporated by reference in their entirety.

### TECHNICAL FIELD

The present disclosure generally relates to the field of lithium recovery from spodumene ore.

### BACKGROUND OF THE ART

As the global demand for lithium continues to grow, there is an increasing pressure for the extraction of lithium from ores such as spodumene. In the recovery of lithium from spodumene, spodumene concentration is usually performed by flotation or a combination of flotation and dense media separation. After the concentration step, spodumene concentrate is usually calcined to allow lithium extraction using conventional hydrometallurgical processes such as sulfuric acid leaching.

The flotation process requires many steps to achieve satisfactory metallurgical performance: crushing, ore sorting, fine grinding, fines removal, conditioning, mica removal (if needed), spodumene flotation (in multiple steps), magnetic separation, filtration and calcination. Given the complexity and numerous steps needed, lithium recovery in this process is generally less than 80%. Furthermore, the use of chemical reagents complicates the residue disposal. Dense media separation is another spodumene concentration method, but it is not applicable to all spodumene deposits, and recovery by this method is typically below 50%.

Recently, it was found that calcination and selective screening of β-spodumene significantly improves the yield of lithium while limiting or eliminating the need for flotation and the steps associated thereto (WO2022/204787).

However, additional improvements to the recovery yield are desired.

### SUMMARY

In one aspect, there is provided a method of recovering lithium concentrate from an ore containing spodumene, the method comprising: crushing the ore to obtain a fine fraction and a coarse fraction; calcining the coarse fraction, preferably at a temperature of from about 950 to about 1100° C., to obtain a calcined coarse fraction comprising spodumene particles having a beta crystal structure; selectively screening the calcined coarse fraction to separate out the spodumene particles and produce screened spodumene particles; and/or performing a magnetic separation on the screened spodumene particles to concentrate the spodumene particles and separate out non-magnetic contaminants to obtain the lithium concentrate.

In some embodiments, the lithium concentrate comprises at least about 3% of Li₂O.

In some embodiments, selectively screening comprises vibratory screening, air classification, cyclone sizing or any other means of separation by size.

In some embodiments, crushing comprises mechanical grinding and/or milling.

In some embodiments, the coarse fraction comprises particles having a size of 850 μm or more.

In some embodiments, the coarse fraction comprises particles having a size of 500 μm or more.

In some embodiments, the particles of the coarse fraction have a size of up to 15 mm.

In some embodiments, the spodumene particles have a size of at least about 300 μm.

In some embodiments, the method further comprises obtaining a lithium salt from the lithium concentrate.

In some embodiments, the lithium salt is LiOH, Li₂O, and/or Li₂CO₃.

In some embodiments, the magnetic separation is performed with magnetized rolls or drums.

In some embodiments, a Rare Earth rolls magnetic separator is used in the magnetic separation.

In some embodiments, a multiple pass magnetic separator is used in the magnetic separation.

In some embodiments, the multiple pass magnetic separator is a 3 pass magnetic separator.

In another embodiment, the method described herein further comprises the step of determining the degree of fragilization of the spodumene particles in the calcined coarse fraction.

In an embodiment, the degree of fragilization is determined by microscopy, macroscopic visual inspection or size distribution analysis.

In an additional embodiment, the method described herein further comprises grinding and/or milling of the spodumene particles is performed if the degree of the degree of fragilization of the spodumene particles is below a pre-determined threshold.

In an embodiment, the threshold is that the spodumene particles have a size about 4 times smaller than the mineral particles, about 4.25 times smaller, 4.5 times smaller, or preferably 5 times smaller than the mineral particles.

In an additional embodiment, the method described herein further comprises the step of autoclaving the lithium concentrate to produce a slurry.

In an embodiment, an additive salt and/or an aqueous phase is added during the autoclaving.

In an additional embodiment, the method described herein further comprises biocarbonation of the slurry producing a LiHCO₃ containing solution.

In an embodiment, biocarbonation removes impurities.

In another embodiment, the method described herein produces lithium concentrate with less than 0.5% impurities content.

In an embodiment, calcining the coarse fraction changes the spodumene particles crystalline structure from alpha to beta crystal structure. The calcining of the coarse fraction can be done using natural gas, propane, heavy oil, biomass, and/or electricity, using e.g. a directly heated rotary kiln, an indirectly heated rotary kiln, and/or a fluidized bed.

In one aspect, there is provided a lithium ion battery comprising a lithium salt produced by the method of the present disclosure.

Many further features and combinations thereof concerning the present improvements will appear to those skilled in the art following a reading of the instant disclosure.

### DESCRIPTION OF THE DRAWING

FIG. 1 is a flow diagram showing a method according to an embodiment of the present disclosure.

### DETAILED DESCRIPTION

The method of the present disclosure seeks to improve the yield of lithium recovered from an ore, a concentrate, or a waste material, with the addition of a magnetic separation step performed after calcination (i.e., a magnetic separation on the β-spodumene). Magnetic separations are routinely performed upstream of the calcination (when the spodumene is an α-spodumene) to remove iron-bearing gangue impurities (minerals) associated with spodumene. For example, a high-intensity magnetic separator can be used for the removal of iron-bearing impurities. However, it was surprisingly found herein that β-spodumene can be further purified as a magnetic species to remove contaminants such as quartz and other non-magnetic gangue minerals. This process is therefore opposite from the traditional magnetic separations performed upstream on α-spodumene, where the α-spodumene is the non magnetic mineral species and iron-rich magnetically stronger contaminants are removed.

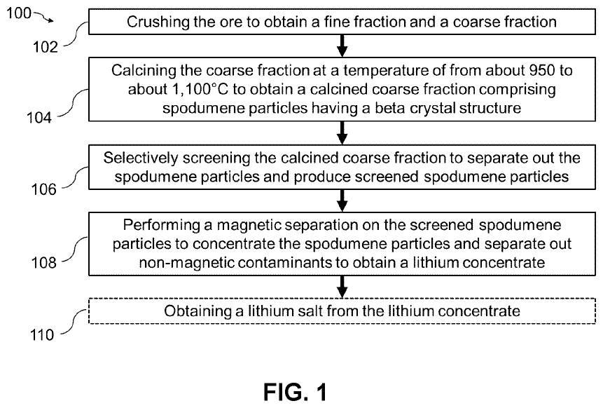

Making reference to FIG. 1, there is provided a method 100 of producing a lithium concentrate. First, an ore obtained from a mine is crushed into a fine fraction and a coarse fraction 102. Alternatively, a concentrate or a waste material containing lithium can be provided. Crushing of the waste material can be performed as needed. Accordingly, after the completion of step 102 a crushed product can be obtained. Generally, the ore comprises spodumene (as well as other minerals). The ore can be a run of mine (ROM) ore comprising spodumene or spodumene concentrate. Spodumene comprises the majority of the lithium present in the ore. In some examples, at least 95% of the lithium in the ore is contained in spodumene. The ore can be crushed to a have a size lower than about 15 mm. Crushing the ROM allows for the dissociation of spodumene grains that may be associated with other minerals. As such, in some embodiments, the method comprises crushing the ROM ore to obtain crushed ore particles having a size lower than 15 mm and in some embodiments, lower than 6 mm. The crushed ore results in a fine fraction and a coarse fraction. Spodumene ore feeding the process can have any Li₂O grade and can be run of mine, pre-concentrated or concentrated ore from any process. Examples of pre-concentration/concentration process may include ore sorting, dense media separation, flotation, magnetic separation, and/or other. As explained herein, in some embodiments, flotation and dense media separation are excluded from the present process when performed on calcined ore (as opposed to calcined concentrates). In that case, flotation and dense media separation are not necessary and therefore only increase the cost and complexity without significantly impacting the yield of lithium that can be obtained. However, dense media separation can be used before calcination on the coarse fraction only to reduce mass to calcine/reduce energy requirement for the calcination, but this is only optional. In some embodiments, flotation can be optionally be applied to the fine fractions. In some embodiments, dense media separation is applied to the coarse fraction and flotation is applied to the fine fraction. In embodiments where the starting material is concentrates, dense media separation and flotation can be performed. In another embodiment, it is encompassed the fine fraction can be can also be calcined. The lithium contained in the calcination product can be recovered through sieve and magnetic separator.

In further embodiments, the method comprises sorting the crushed product to obtain the fine fraction and the coarse fraction. This can be performed by a size separation method (e.g., screening with a mesh of the appropriate size or air classification). In one embodiment, the term “fine fraction” as used herein refers to the fraction containing particles having a size of less than about 850 μm, less than about 700 μm, less than about 600 μm, less than about 500 μm, less than about 400 μm, or less than about 300 μm. The minimum size of the fine fraction can for example be 45 μm. The term “coarse fraction” as used herein refers to the fraction containing particles having a size larger than the fine fraction. For example, the coarse fraction contains particles having a size of at least about 300 μm, at least about 400 μm, at least about 500 μm, at least about 600 μm, at least about 700 μm, or at least about 850 μm or higher.

Separating the fine and coarse particle into their respective fine and coarse fractions prior to calcination may increase the gangue/spodumene separation efficiency of the coarse particles. This may result in a higher spodumene concentration (higher concentrate grade).

Then, a calcination step 104, is conducted on the coarse fraction derived from crushed ore. In some embodiments, the coarse fraction is provided “as crushed” and there are no other separation steps performed on the coarse fraction. For example, no flotation or dense media separation is performed on the coarse fraction in between the crushing and calcining. On the other hand, the fine fraction can be subjected to a flotation, and/or any other suitable separation process to extract the lithium therefrom. In the present disclosure, the coarse fraction is of interest. One objective of the present method is to reduce the amount of material (e.g., by up to 90%) subjected to flotation and/or dense media separation by not including the coarse fraction that is instead subjected to the separation method described herein. Significant cost reductions can therefore be achieved because flotation and dense media separation require a multitude of steps and equipment.

The calcination 104 is performed to modify the crystal structure of the spodumene particles which later allows for a selective screening 106. Spodumene is naturally occurring in its alpha crystalline structure (i.e., α-spodumene) which is relatively stable (and in some embodiments resistant to chemical degradation). To allow the selective screening of lithium-containing particles (spodumene) from the calcined ore, a change in spodumene crystalline structure from alpha to beta phase is performed during calcination 104 to obtain β-spodumene.

DRX analysis showed that the conversion from alpha to beta is above 90%, achieving as 100% conversation rate.

The calcination 104 of spodumene ore can be done with any energy source including, but not limited to: natural gas, propane, heavy oil, biomass, and/or electricity. The calcination 104 can be performed by direct or indirect heating with any calcination equipment including but not limited to: directly heated rotary kiln, indirectly heated rotary kiln, fluidized bed and/or any other similar equipment. Electricity powered calcination equipment can be heated by electric resistance, electric arc plasma torch, microwave, or by any other similar device.

In some embodiments, the calcination 104 modifies the crystal structure (from alpha to beta) of at least 90%, 91%, 92%, 93%, 94%, 95%, 96%, 97%, 98%, 99% or more of the spodumene calcined particles. In one particular embodiment, the totality (i.e., 100%) of the crystal structure of calcined spodumene particles is in the beta phase. More specifically, in some embodiments, the crystal structure of spodumene expands and fragilizes during calcination 104. The term “fragilize” as used herein is defined as the transition of spodumene particles from an alpha to a beta crystal structure. The term “fragilize” may be further defined as having a compromised structural integrity (for example having one or more fractures) in the spodumene particles.

A selective screening 106 of the calcined coarse fraction to separate out the spodumene particles and produce screened spodumene particles, which is possible because other minerals present in the coarse and fine ore particles that are being submitted to calcination 104 do not substantially change their crystal structure. The other (non spodumene) minerals are not significantly fragilized by calcination 104 since they substantially maintain the same crystal structure.

In one embodiment, the calcination 104 is performed at a temperature of between about 950 and between about 1 100° C., between about 975 and about 1 080° C., between about 1 000 and about 1 070° C., between about 1 030 and about 1 060° C., between about 950 and about 1 060° C., between about 950 and 1 050° C., or about 1 050° C. It is understood that calcining below the temperature of about 950° C. would not induce the change in the crystal structure of spodumene and calcining above the temperature of about 1100° C. may soften and melt (liquefy) some other minerals in the ore. Thus in one embodiment, the calcination temperature is at most about 1 100° C. In some embodiments, the calcination is performed at a temperature of about 1 050° C. In some embodiments, the calcination 104 is performed at atmospheric pressure. In further embodiments, the calcination is performed during a time period between about 5 minutes and about 60 minutes, between about 10 minutes and about 50 minutes, between about 15 minutes and about 45 minutes, between about 20 minutes and about 40 minutes, between about 25 minutes and about 40 minutes; or between about 30 minutes and about 35 minutes. The calcination 104 yields a calcined ore that comprises calcined spodumene and other minerals such as quartz and/or other gangue materials.

Following calcination 104, optionally, a degree of fragilization of calcined spodumene can be determined. The term “degree of fragilization” as used herein can refer to a measure of the susceptibility of a particle to lose at least a portion of its structural integrity (i.e., to break). The degree of fragilization is also an indication of the suitability of particles to be subjected to a selective screening 106. Determining the degree of fragilization may be done at predetermined time intervals during operation to control/adjust the process. If the particles are not suitable for the selective screening based on their degree of fragilization then further grinding (selective spodumene grinding) and/or milling is indicated and can be performed to increase fragilization. The degree of fragilization can be determined from the crystal structure of particles based on a direct or indirect analysis. For example, a direct analysis can be performed by observing the crystal structure by microscopy. In another example, an indirect analysis can be performed by macroscopic visual inspection or size distribution analysis to determine the degree of fragilization. If the degree of fragilization of a calcined spodumene is below a pre-determined threshold, grinding and/or milling is performed to bring the degree of fragilization equal to or above the pre-determined threshold. In one example, the threshold can be that the spodumene particles have a size about 4 times smaller than the other (non spodumene) mineral particles. In further embodiments, the threshold can be that the spodumene particles have a size about 4.25 times smaller, 4.5 times smaller, 5 times smaller, or more when compared to the size of the other (non spodumene) mineral particles. Once the degree of fragilization is above the pre-determined threshold the calcined spodumene can be subject to the step of selectively screening 106. If the degree of fragilization of a calcined spodumene is determined to be above a pre-determined threshold of fragilization then the calcined ore can be directly provided for the selective screening 106. Thus in some embodiments, the degree of fragilization can additionally be determined after the grinding and/or milling to assess whether the grinding and/or milling was sufficient. When warranted, the grinding and/or milling can be performed before or concurrently with the selective screening 106. Examples of grinding include but are not limited to: adding steel/ceramic balls on the screening deck to fragilize spodumene particles, performing an attrition before screening, performing a soft ball milling prior to screening, and combinations thereof. Accordingly, in some embodiments, the method further comprises determining a degree of fragilization of calcined spodumene particles. In further embodiments, the method further comprises grinding and/or milling the calcined ore prior to or during the selectively screening 106.

The method of the present disclosure provides selective screening 106 to separate the calcined spodumene particles from the other minerals in the calcined coarse fraction that may be present in the ore and therefore to obtain screened spodumene particles. The selective screening can be performed to obtain screened spodumene particles having a size below about 300 μm. The selective screening can be conducted with a suitable screen (or mesh) for example having an opening (aperture) size of between equal to or higher than about 25 μm, equal to or lower than about 300 μm and in some specific embodiments, between about 45 to about 300 μm. In some embodiments, the selectively screened spodumene particles have a size of less than 300 μm, less than 290 μm, less than 280 μm, less than 270 μm, less than 260 μm, or less than 250 μm. In one embodiment, the selective screening 106 comprises the use of a vibratory screen, air classifier, an air classifier, cyclone sizing and/or any other means of separation by size. The vibration and other similar means can be used to facilitate and/or accelerate the screening.

It was presently discovered that the screened spodumene particles can further be processed using magnetic separation 108 after the calcination 104 and selective screening steps 106 to recover β-spodumene particles from other non-magnetic particles such as quartz and other gangue minerals. During the magnetic separation process, iron oxide minerals/particles and the screened spodumene particles having a significant amount of iron in their beta crystal structure are concentrated in the magnetic product while quartz and other gangue minerals are concentrated in the non-magnetic product. This is because the iron inclusions in the spodumene crystal increase the magnetic susceptibility of the β-spodumene particles during the alpha to beta conversion. The magnetic separation therefore further improves lithium concentrate quality. This magnetic separation should not be confused with the magnetic separation that is conventionally used in the industry upstream to separate iron oxide from alpha-spodumene. In contrast, in the magnetic separation step 108 is used to separate magnetic iron-containing beta-spodumene from other minerals/particles. One advantage of the magnetic separation process 108 is that it can be a dry process, without any wetting, filtration and drying of the product(s), thereby reducing the number of steps performed and the costs of the overall method.

Generally, iron is provided from two distinct sources: iron bearing minerals (normally separated by magnetic separation from alpha spodumene) and the iron contained in spodumene crystals (alpha & beta). The incorporation of iron in the spodumene crystal structure happens during geological formation of spodumene. The iron content in alpha and beta spodumene is generally considered similar. However, alpha spodumene is non-magnetic. The roasting of alpha spodumene oxidize the iron contained in its crystal structure and increase its magnetic susceptibility. Therefore, beta spodumene is weakly magnetic and can be separated efficiently from non-magnetic gangue minerals. Spodumene crystals iron level can vary in different spodumene deposits which will impact its magnetic behaviour after calcination.

In some embodiments, the magnetic separation is performed with a rare earth roll magnetic separator. Due to the magnetic field exerted by the magnetics, the more magnetic particles are drifted by the movement of the magnetic roll. This can create a magnetic concentrate, in this case the β-spodumene particles. Preferably, before the calcination step, iron bearing minerals (which are magnetic) are removed by magnetic separation from non-magnetic alpha spodumene. This can, for example, be done using either a Wet High Intensity Magnetic Separator for a wet process or a Rare Earth Rolls magnetic separator for dry processing. However, this is performed before the present process (i.e., before step 102). After the calcination step 104, weakly magnetic beta spodumene is separated from non-magnetic gangue minerals using a Rare Earth rolls magnetic separator (high intensity magnetic field). Preferably a multiple pass magnetic separator is used for example a 3 pass (3 rolls) magnetic separator to obtain a better quality product.

A lithium concentrate can be used to obtain a lithium salt 110. A lithium salt is obtained 110 from the lithium concentrate by any suitable method. The lithium salt can be a commercially desirable salt, for example LiOH, Li₂O, and/or Li₂CO₃. Accordingly, in some embodiments, the method comprises obtaining a lithium salt from the lithium concentrate. In some embodiments, these methods can produce battery grade lithium carbonate with less than 0.5% impurities content.

In one example, a hydrometallurgical process is performed to obtain LiOH from the lithium concentrate. The lithium concentrate is first autoclaved to obtain a slurry. Autoclaving can be performed for example by adding an additive salt (e.g., a sodium salt) and an aqueous phase (e.g., water). The autoclaving can for example be performed at a temperature of between about 200 and 240° C. and at a pressure of between about 320 to between about 360 psi (i.e., 2.2-2.48 MPa). The autoclaving can be performed under agitation. The autoclaving can be performed for at least 60 minutes. The slurry obtained from the autoclave can then be converted into a suspension, namely a mixture of LiOH and CaO (for example a slurry) by adding water and CaO to have the lithium in soluble form. The mixture of LiOH and CaO can then be filtered to obtain a LiOH filtrate that comprises LiOH. The LiOH is then precipitated by crystallization to obtain LiOH crystals suspended in solution. In one embodiment, the precipitation is performed by varying pressure (e.g., vacuum) and/or temperature to evaporate the liquid components of the filtrate. LiOH crystals can then be separated from the solution by centrifugation or other similar means of solid/liquid separation. By optionally dissolving the LiOH crystals (e.g., in a dissolving tank) the LiOH crystals can be subjected to further steps of precipitation (crystallization) and separation to recover more lithium and reduce the impurities content. The precipitated LiOH crystals are then dried to obtain dry LiOH crystals which can then be optionally packaged. In one example, the drying can be performed at a temperature of between 5° and 90° C. or until all free water is removed and lithium hydroxide is in a monohydrate form. The packaging can be, for example, a packaged air-tight bag.

In another example, the lithium concentrate is autoclaved to obtain a slurry. The autoclaving can be performed under the same conditions as the autoclaving for LiOH. Autoclaving can be performed for example by adding an additive salt (e.g., a sodium salt) and an aqueous phase (e.g., water). The autoclaving can for example be performed at a temperature of between about 200 and 240° C. and at a pressure of between about 320 to between about 360 psi (i.e., 2.2-2.48 MPa). The autoclaving can be performed under agitation. The autoclaving can be performed for at least 60 minutes. After the digestion by autoclaving, the slurry can be sent to a bicarbonation tank for bicarbonating to obtain a LiHCO₃ containing solution. The bicarbonation step can be operated with, for example, a CO₂ injection at between 140 and 160 psi (i.e., 0.965-1.1 MPa) at room temperature (e.g., 150 psi/1.03 MPa and 20° C.). The bicarbonation transforms moderately soluble lithium carbonate into more soluble lithium bicarbonate in solution (e.g., solubilized slurry). The solution is then filtered in order to remove aluminosilicates residue. The filtrate is heated to 95° C. to remove CO₂ which may be recycled to the bicarbonation step. The CO₂ removal driven by heating further converts lithium bicarbonate to lithium carbonate which has a lower solubility and precipitates. The precipitated lithium carbonate can then be separated from the liquid phase with any suitable means for example a centrifugation. Depending on initial feedstock quality, a second bicarbonation step can optionally be performed to remove impurities. Removing impurities may thus comprise a second precipitation and centrifugation with the same conditions as above. Furthermore removing impurities can optionally further include an ion exchange such as an ion exchange chromatography to further improve the purity. Finally, the crystals can be dried and packaged.

In some embodiments, the lithium concentrate comprises at least about 3% Li₂O. In some embodiments, the other mineral particles of the calcined ore (that are not retained by the selective screening) comprise less than 2% Li₂O. Since the lithium concentrate is not obtained with the use of chemical additives (e.g., flotation), but instead by physical separation (i.e., selectively screening 106 and magnetic separation 108), in one embodiment, the method of producing a lithium concentrate according to the present disclosure is free of chemical reagents and contamination (for example flotation reagents). The absence of chemical contaminants reduces the environmental footprint of the method of the present disclosure when compared to methods of the prior art that include flotation. Indeed, the residue waste generated by the present method can be easily disposed since it can be free of harmful reagents in contrast to residues generated by the prior art.

The method of the present disclosure advantageously achieves a lithium recovery of at least 80%, at least 85%, at least 87%, at least 88%, at least 89% or at least 90% in the lithium concentrate. The lithium recovery represents the amount of lithium contained in the concentrate divided by the amount of lithium contained in the ROM ore.

The fabrication of a lithium ion battery is contemplated within the present disclosure. A lithium salt (e.g., LiOH or Li₂CO₃) can be obtained by the methods of the present disclosure and included in the battery. For example, the lithium can be included in an electrode of the battery. Methods of fabricating batteries are well known to the person skilled in the art.

### EXAMPLE

A lithium concentrate was produced as follows. First, run of mine (ROM) ore was crushed until the adequate liberation degree of spodumene was reached, specifically to a maximal size of from 6 to 15 mm, to thereby obtain crushed ore particles. The crushed ore particles were screened to separate coarse ore particles (0.9 ton) from fine ore particles (0.1 ton). The fine ore particles having a size of less than 850 μm with a total weight 0.1 ton were separated by screening.

The coarse ore particles were calcined by heating at 1050° C. under atmospheric pressure. The crystal structure expanded and fragilized the spodumene grains thereby yielding calcined ore. Other minerals were not significantly fragilized and kept substantially the same crystal structure. Due to spodumene fragilization occurring during calcination, spodumene grains broke or could be easily broken in smaller grains. The spodumene grains were separated from other coarser mineral grains by screening to obtain a screened spodumene particles. The following procedure was performed on two ores, labelled ore 1 (Table 1) and ore 2 (Table 2).
1—Crushing the ore to 6.7 mm,
2—Removing the fine fraction (less than 850 μm) by sieving using a RO-Tap sieve shaker,
3—Performing a magnetic separation on the coarse fraction (more than 850 μm) to remove iron bearing minerals (using a rare earth rolls magnetic separator, 1 pass, 50 rpm roll speed, 0.13 mm Kevlar belt, 3:1 magnet configuration, magnetic separator model: Outokumpu Technology high-force laboratory separator L/P 10-30),
4—Calcining the non-magnetic coarse fraction in a muffle furnace at 1050° C. for 30 minutes,
5—Screening the calcined ore at 212 and 75 microns with a RO-TAP sieve shaker, and
6—Performing a magnetic separation on the 75-212 μm fraction to separate magnetic beta spodumene from non-magnetic gangue minerals (same magnetic separator/parameters used at step 3).

To obtain a lithium salt, the lithium concentrate was submitted to a hydrometallurgical process. More specifically, the lithium concentrate was mixed with Na₂CO₃ and water in an agitated autoclave for 60 minutes or more at 180-220° C. at 340 psi (equivalent to 2.34 MPa). The lithium in the spodumene structure was substituted by aqueous sodium ions during the reaction. As a result, the lithium concentrate formed lithium carbonate which has a moderate solubility. Lithium carbonate was mainly present as a precipitate.

For lithium hydroxide production, the slurry exiting the autoclave was subject to a conversion to convert Li₂CO₃ to highly soluble LiOH with CaO. The residue of the filtration was a reject containing aluminosilicates and CaCO₃ (from the reaction between CaO and Li₂CO₃). The filtrate contained LiOH and was sent to a first crystallizer where water was evaporated under vacuum in order to precipitate LiOH. LiOH crystals were separated from the remaining solution with a centrifuging. Depending on initial feedstock quality, a dissolution step was optionally performed and a second crystallization to decrease impurities level and centrifugation followed. Finally, the product was dried (LiOH(H₂O)).

The results are presented for the two different ores, Ore 1 (Table 1) and Ore 2 (Table 2). For Ore 1, a 1.05% Li₂O head sample has been upgraded by screening at 212 μm achieving 62.7% Li recovery at 5.1% Li₂O grade (Table 3) whereas only a grade of 3.6% was obtained without magnetic separation. For Ore 2, a 1.11% Li₂O head sample has been upgraded by screening at 212 μm achieving 93.1% Li recovery at 5.8% Li₂O grade (Table 4) whereas only a grade of 4.9% was obtained without magnetic separation.

TABLE 1
Characterization of Ore 1

| | Li₂O | Mass | Li Yield |
|---|---|---|---|
| Ore 1 | % | % | % |
| Head | 1.19 | 100.0 | 100.0 |
| Plus 212 μm (Reject) | 0.19 | 80.0 | 12.9 |
| N-Mag (Reject) | 3.51 | 8.1 | 23.8 |
| Mag (Conc) | 6.14 | 3.9 | 20.0 |
| Minus 75 μm (Conc) | 6.39 | 8.0 | 43.3 |

TABLE 2
Characterization of Ore 2

| | Li₂O | Mass | Li Yield |
|---|---|---|---|
| Ore 2 | % | % | % |
| Head | 1.11 | 100 | 100 |
| Plus 212 μm (Reject) | 0.08 | 78.5 | 5.7 |
| N-Mag (Reject) | 0.38 | 3.5 | 1.2 |
| Mag (Conc) | 4.77 | 6.9 | 29.6 |
| Minus 75 μm (Conc) | 6.4 | 11.1 | 63.5 |

TABLE 3
Results for Ore 1

| | Li₂O | Mass | Li Yield |
|---|---|---|---|
| Without magnetic separation | 5.2% | 20.0% | 87.1% |
| With magnetic separation | 6.3% | 11.9% | 63.3% |

TABLE 4
Results for Ore 2

| | Li₂O | Mass | Li Yield |
|---|---|---|---|
| Without magnetic separation | 4.9% | 21.5% | 94.3% |
| With magnetic separation | 5.8% | 18% | 93.1% |

While the present disclosure has been described in connection with specific embodiments thereof, it will be understood that it is capable of further modifications and this application is intended to cover any variations, uses, or adaptations including such departures from the present disclosure as come within known or customary practice within the art and as may be applied to the essential features hereinbefore set forth, and as follows in the scope of the appended claims. Features which are described in the context of separate aspects and embodiments of the invention may be used together and/or be interchangeable. Similarly, features described in the context of a single embodiment may also be provided separately or in any suitable subcombination.

1. A method of recovering lithium concentrate from an ore containing spodumene, the method comprising:
crushing the ore to obtain a fine fraction and a coarse fraction;
calcining the coarse fraction, preferably at a temperature of from about 950 to about 1100° C., to obtain a calcined coarse fraction comprising spodumene particles having a beta crystal structure;
selectively screening the calcined coarse fraction to separate out the spodumene particles and produce screened spodumene particles; and
performing a magnetic separation on the screened spodumene particles to concentrate the spodumene particles and separate out non-magnetic contaminants to obtain the lithium concentrate.

2. The method of claim 1, wherein the lithium concentrate comprises at least about 3 wt. % of Li₂O.

3. The method of claim 1, wherein selectively screening comprises vibratory screening, air classification, cyclone sizing and/or any other means of separation by size.

4. The method of claim 1, wherein the crushing comprises mechanical grinding and/or milling.

5. The method of claim 1, wherein the coarse fraction comprises particles having a size of 500 μm or more.

6. (canceled)

7. (canceled)

8. The method of claim 1, wherein the spodumene particles have a size of at least about 300 μm.

9. The method of claim 1, further comprising obtaining a lithium salt from the lithium concentrate.

10. The method of claim 9, wherein the lithium salt is LiOH, Li₂O, and/or Li₂CO₃.

11. The method of claim 1, wherein the magnetic separation is performed with magnetized rolls or drums.

12. The method claim 1, wherein a Rare Earth rolls magnetic separator is used in the magnetic separation.

13. The method of claim 1, wherein a multiple pass magnetic separator is used in the magnetic separation.

14. (canceled)

15. The method claim 1, further comprising the step of determining the degree of fragilization of the spodumene particles in the calcined coarse fraction.

16. The method of claim 15, wherein the degree of fragilization is determined by microscopy, macroscopic visual inspection or size distribution analysis.

17. The method of claim 15, wherein further grinding and/or milling of the spodumene particles is performed if the degree of fragilization of the spodumene particles is below a pre-determined threshold.

18. (canceled)

19. The method of claim 1, further comprising the step of autoclaving the lithium concentrate to produce a slurry.

20. (canceled)

21. The method of claim 19, further comprising bi carbonation of the slurry producing a LiHCO₃ containing solution.

22. (canceled)

23. The method of claim 1, producing lithium concentrate with less than 0.5 wt. % impurities content.

24. The method of claim 1, wherein calcining the coarse fraction changes a crystalline structure the spodumene particles from an alpha crystal structure to the beta crystal structure.

25. The method of claim 1, wherein calcining the coarse fraction is done using natural gas, propane, heavy oil, biomass, and/or electricity; or wherein calcining the coarse fraction is done using a directly heated rotary kiln, an indirectly heated rotary kiln, and/or a fluidized bed.

26. (canceled)

27. A lithium ion battery comprising a lithium salt produced by the method of claim 9.

28. (canceled)
